(19) United States
(12) Patent Application Publication
(10) Pub. No.: US 2014/0231396 A1
(43) Pub. Date: Aug. 21, 2014

(54) METHOD FOR RESISTANCE WELDING WITH PRE-CHILLING

(71) Applicant: GM GLOBAL TECHNOLOGY OPERATIONS LLC, Detroit, MI (US)

(72) Inventors: David Yang, Shanghai (CN); David R. Sigler, Shelby Township, MI (US); Jing Zhang, Shanghai (CN)

(21) Appl. No.: 13/769,457

(22) Filed: Feb. 18, 2013

(51) Int. Cl. B23K 11/11

(52) U.S. Cl. CPC B23K 11/11
USPC 219/91.2

(57) ABSTRACT

A method for improving a resistance spot weld includes stacking two or more metal sheets and positioning first and second opposed electrodes on opposite sides of the metal stack. At least one of the metal sheets is chilled in the region where the weld is to be made. Weld current is applied to the electrodes and passes through the metal sheets to create the electric resistance spot weld only after the chilling of the at least one metal sheet reduces the temperature at the faying interface at least 5° C., thereby improving the formation of the weld nugget and quality of the weld joint. The chilling can be obtained by flowing chilled gas onto the surface of one or both of the outermost metal sheets, or by contacting the outermost metal sheets with the chilled electrode for a period of time prior to applying the weld current.

### FIELD OF THE INVENTION

The present invention relates to an improved method for electric resistance welding, and more particularly improving the welding process by optimizing the heat distribution throughout the metal stack-up by selective pre-chilling of the metal sheets.

### BACKGROUND OF THE INVENTION

Electric resistance welding is often employed to join together a stack-up of two or three metal sheets, particularly in the construction of automobile bodies and other manufactured articles.

Electric resistance welding (ERW) refers to a group of welding processes such as resistance spot welding (RSW) that produce coalescence of faying surfaces where heat to form the weld is generated by electrical resistance as electric current is applied to the sheets and force is used to hold the metal sheets together. Some factors influencing the control of the heat and welding temperatures are the thickness of the metal sheets, the materials and metallurgy of the metal sheets, the coating or the lack of coating, the electrode materials, electrode geometry, electrode pressing force, weld current and weld time.

Usually, two copper electrodes are simultaneously used to clamp the metal sheets together and to pass current through the sheets. When the current is passed through the electrodes to the sheets, heat is generated. As the electrical resistance causes a heat buildup in the work pieces between the copper electrodes, the rising temperature results in a molten pool at the interface between the metal sheets in the region of contact by the electrodes. After a matter of tenths of a second, current flow is terminated and heat is dissipated throughout the metal sheets and the copper electrodes to cool the spot weld, causing the molten nugget to solidify under pressure. The copper electrodes are water cooled to extend electrode life and to remove the surface heat quickly, accelerating solidification of the nugget, since copper is an excellent conductor.

In many welding applications, the two metal sheets are of sufficient thickness and of the same metallurgical material so that quality of the resulting spot weld can be readily controlled by adjusting such variables as electrode weld force, weld current, and weld time.

However, control of the spot welding process is more challenging in those instances where both of the sheets are of thin gauge material. Control of the welding process is also more challenging where the two sheets have differences of thickness and/or material that will result in a heat imbalance between the sheets when the sheets are heated by the current flowing between the electrodes. By imbalance, we mean that one of the metal sheets heats much more rapidly and obtains a much higher temperature than the other metal sheet.

There are several situations that cause heat imbalances. For example, heat imbalances can result when the metal sheets have differences in thickness. This difference in-thickness causes the faying interface between the two metal sheets to be much closer to one copper electrode than the other, thus causing a heat imbalance situation in which the thinner sheet is cooled much more effectively by the electrode than the thicker sheet, thus causing the thicker sheet to reach higher temperatures than the thinner sheet.

As another example, heat imbalances can result when the metal sheets are of different materials having different electrical properties. For example, one material can be an advanced high strength steel (AHSS) such as Dual Phase (DP) steel, Transformation Induced Plasticity (TRIP) steel or press hardened steel (PHS) which has a high bulk resistivity. The other material can be a low carbon steel or interstitial free (IF) steel which has a very low bulk resistivity. The passage of current through the metal sheets will cause more rapid heating of the AHSS material compared to the low carbon or IF steel material. Additional heat imbalance complexities occur when for example welding a thin gauge low carbon or IF galvanized steel sheet to a heavier gauge DP, TRIP, or PHS steel sheet.

These heat imbalances result in several problems. First, heat imbalances caused by high thickness ratios, differing resistivity, or both, result in much greater penetration of the nugget into one sheet compared to the other sheet. For the sheet with excessive nugget penetration, this can produce undesirable effects between the electrode and metal sheet that include electrode sticking, excessive electrode wear, surface expulsion, and possible formation of weld surface cracks. For the sheet with reduced nugget penetration, the process can become unstable with small variations in nugget volume causing large variations in weld button size and, thus, weld strength.

It would be desirable to provide a new and improved method for improving the control and quality of electric resistance spot welding in those instances where the selection of the metal sheets results in the occurrence of heat imbalances between the sheets during the spot welding process.

### SUMMARY OF THE INVENTION

A method for improving a resistance spot weld includes stacking first and second metal sheets and positioning first and second opposed electrodes on opposite sides of the metal stack. At least one of the metal sheets is chilled in the region where the weld is to be made. Weld current is applied to the electrodes and passes through the metal sheets to create the electric resistance spot weld only after the chilling of the at least one metal sheet reduces the temperature at the faying interface at least 5° C., thereby improving the formation of the weld nugget and quality of the weld joint. The chilling can be obtained by flowing chilled gas onto the surface of one or both of the metal sheets, or by contacting the metal sheets with the chilled electrode for a period of time prior to applying the weld current. In the case of a stack up of three metal sheets, the chilling is obtained by flowing chilled gas onto the surface of one or both of the outermost metal sheets of the metal stack, or by contacting the outermost metal sheets of the metal stack with the chilled electrode for a period of time prior to applying the weld current.

Applicability of the present invention will become apparent from the detailed description provided hereinafter. It should be understood that the detailed description and specific examples, while indicating exemplary embodiments of the invention, are intended for purposes of illustration only and do not limit the scope of the invention.

### BRIEF DESCRIPTION OF THE DRAWINGS

The present invention will become more fully understood from the detailed description and the accompanying drawings, wherein:

FIG. 1 is an elevation view of a spot weld apparatus, having parts broken away and in section.

FIG. 2 is a plot of temperature versus resistance for a spot welding process.

FIG. 3 is an elevation view of a spot weld apparatus, having parts broken away and in section.

FIG. 4 is a section view taken in the direction of arrows 3-3 of FIG. 3.

FIG. 5 is an elevation view of another spot weld apparatus having parts broken away and in section.

### DETAILED DESCRIPTION OF THE EXEMPLARY EMBODIMENTS

The invention is a new method and apparatus to improve resistance spot welding of steel sheet materials. It consists of an air or gas chiller that is used to cool sheet metal surfaces and the electrodes just prior to and during the spot welding process. The chiller can consist of many different types of apparatus that act to cool the sheet and/or electrode prior to spot welding. It can be integrated into the weld gun or weld gun robot. The chiller consists of a device that delivers a stream or flow of dry, cold gas such as air, nitrogen, or carbon dioxide directly onto the sheet and/or welding electrode. The cooled gas helps control heat imbalances caused by welding of materials with widely dissimilar thickness or bulk resistivity. This is accomplished through cooling of the sheet materials prior to making the weld.

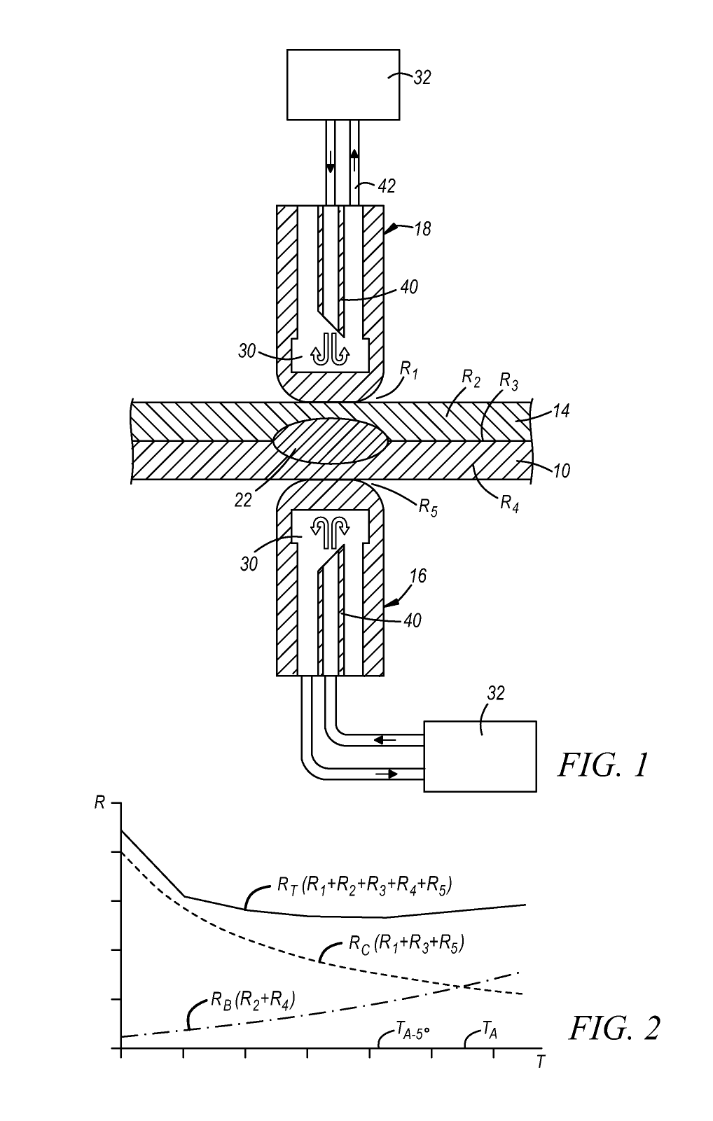

FIG. 1 shows a conventional apparatus for making an electric resistance spot weld. A first metal sheet 10 is to be welded to a second metal sheet 14. The sheets 10 and 14 are stacked one atop the other. A weld-making tool includes a first or lower electric resistance spot welding electrode 16 and a second or upper electric resistance spot welding electrode 18. One or both of the electrodes 16 and 18 are mounted on an actuator for moving the electrodes 16 and 18 toward and away from the stacked sheets 10 and 14. For example, in making a weld, the actuator is actuated to move the first electrode 16 against the first sheet 10 and the second electrode 18 against the second sheet 14. Clamping force is applied to the electrodes 16 and 18 and weld current is applied between the first electrode 16 and the second electrode 18 to create a resistance spot weld nugget 22 between the metal of the first sheet 10 and the second sheet 14. As shown in FIG. 1 each of the electrodes 16 and 18 have an internal cooling chamber 30 that receives liquid coolant to cool the electrodes. The coolant is pumped from coolant source 32 through a pipe 40 into the cooling chamber 30, and then returned to the coolant source through pipe 42.

The weld nugget 22 is created by the heat that is generated when the weld current is conducted between the electrodes 16 and 18. The heat generated is dependent on the electrical resistance of the sheets 10 and 14. In particular, as shown in FIG. 1, the electrical resistance is a combination of the contact resistance R₁ at the interface between the electrode 18 and second sheet 14, the bulk resistance R₂ within the second sheet 14, the contact resistance R₃ at the faying interface between the two sheets 10 and 14 as the sheets are squeezed together, the bulk resistance R₄ within the first sheet 10, and the contact resistance R₅ at the interface between the electrode 16 and the first sheet 10.

FIG. 2 is a graph of resistance versus temperature for the welding setup of FIG. 1. T_{A} is the ambient temperature of the metal stack. R_{T} is the total electrical resistance including R₁, R₂, R₃, R₄, and R₅. R_{B} is the bulk resistance, R₂+R₄, of the sheets 10 and 14. R_{C} is the contact resistance, R₁+R₃+R₅, occurring at the point of contact of the electrodes with the metal sheets and between the two metal sheets 10 and 12. As seen in the graph, the total resistance R_{T} is generally constant irrespective of variation in the temperature. However, the contact resistance Rc, particularly at faying interface resistance R₃ between the sheets 10 and 12 increases as the temperature is reduced.

We have found that the contact resistance R₃, that is the contact resistance at the faying interface between the sheets 10 and 14, is the most significant determinant of achieving an improvement in the welding together of materials of dissimilar thicknesses and bulk resistivity. In particular, we have found that pre-chilling of one or both of the metal sheets by 5° C. (T_{A}−5° C.) or more can significantly improve the welding process. Furthermore, we have found that pre-chilling of the metal sheets from ambient temperature, such a 25° Celsius, down to 0° Celsius is achievable and assures a significant improvement in the welding together of the metal sheets. Preferably cooling of the metal sheets should reduce sheet temperature at least 15° C. and more preferably 15° C. to 35° C.

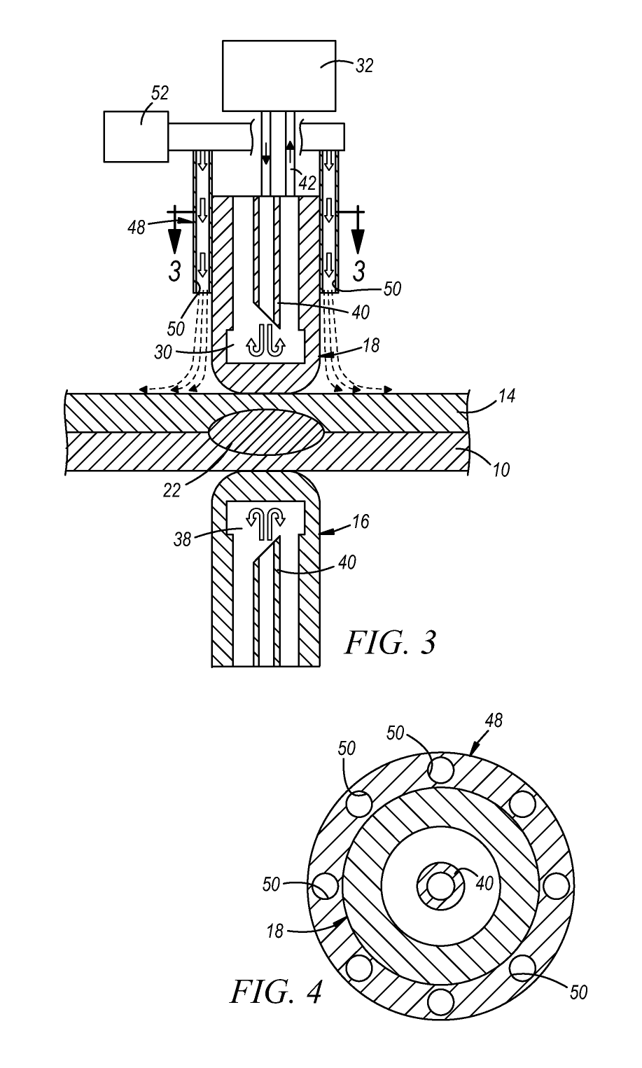

Referring to FIG. 3, a weld making tool similar to FIG. 1 is shown and has like elements identified by like reference numerals. In addition to the elements of FIG. 1, the apparatus of FIG. 3 has a chilling manifold 48 mounted on the second electrode 18. The chilling manifold 48 is annular in shape and surrounds second electrode 18. The chilling manifold 48 has a plurality of axial flow passages or nozzles 50 that are connected to a chilled gas source 52. The chilled gas source 52 provides a flow of chilled gas that flows onto the second sheet 14 in the region surrounding the site where the resistance spot weld nugget 22 will be formed.

According to our invention, the chilled gas will be flowed onto the second sheet 14 for a predetermined time prior to the weld current being applied in order to lower the temperature of the second sheet 14 before attempting the formation of the weld nugget 22. The flow of chilled gas can be initiated either before or after the electrodes make initial contact with the metal sheets. However, preferably, the chilled gas is flowing prior to contact of the electrode 18 with the metal sheet in order to provide additional chilling time without adding to the overall cycle time for accomplishing a welding together of the sheets. It will be understood that the flow rate and temperature of the chilled gas and duration of the flow will determine the extent to which the pre-chilling of the metal sheet 14 will be accomplished.

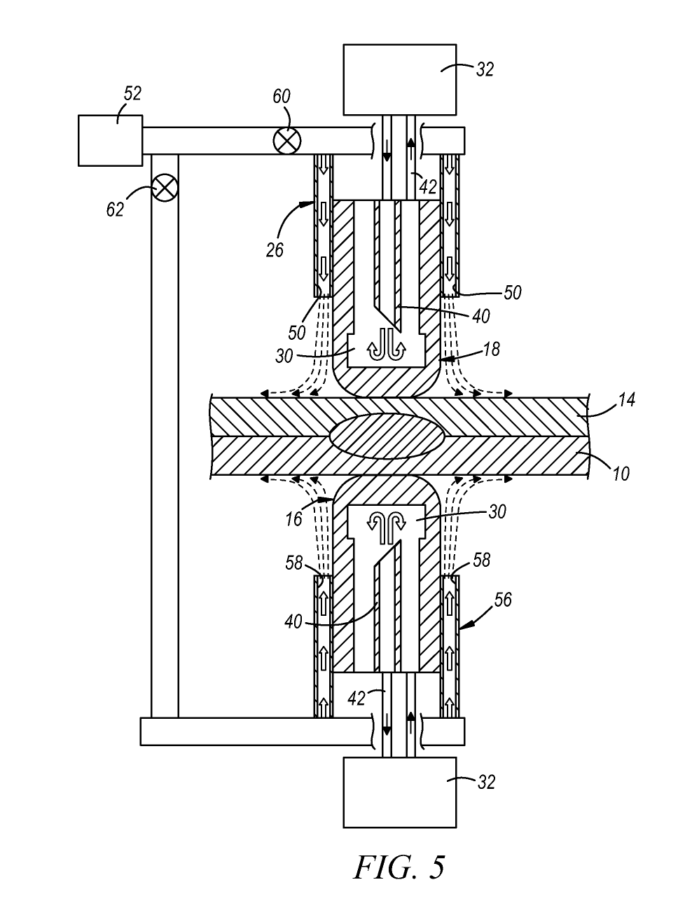

Referring to FIG. 5, a weld making tool similar to FIG. 3 is shown and like elements are identified by like reference numerals. In the example of FIG. 5, the lower electrode 16 has a chilling manifold 56 including nozzles 58 connected to the chilled gas source 36. Thus, in the example of FIG. 5, the chilled gas can be flowed onto the first sheet 10 via the manifold 56 while the chilled gas is flowed onto the second sheet 14 via the chilling manifold 26. Thus, in the example of FIG. 5, both the first sheet 10 and the second sheet 14 can be pre-chilled in the region surrounding the location where the weld nugget 22 will be formed. In addition, FIG. 5 shows a valve 60 for controlling gas flow to manifold 26 of electrode 18, and a valve 62 for controlling gas flow to manifold 56 of the electrodes 16.

Referring again to FIG. 1, it will be understood that the conventional weld making apparatus shown herein can be employed to practice our invention. Although the apparatus of FIG. 1 has no chilled air manifold, the apparatus can nonetheless be used to pre-chill the site where the weld nugget 22 will be formed. In particular, in FIG. 1 the lower electrode 16 and upper electrode 18 are pre-chilled by the circulation of chilled water through the electrodes prior to bringing the electrodes into contact with the lower sheet 10 and upper sheet 14. Then the electrodes are moved into contact with the metal sheets and are poised in contact with the metal sheets 10 and 14 for a period of time sufficient to pre-chill the weld site by conducting away heat from the metal sheets at the site where the weld nugget 22 is to be performed. Thus, in FIG. 1, a conventional set of copper weld electrodes with internal cooling can be employed to practice our invention, albeit with some addition to the overall cycle time of accomplishing the making of a weld 22 between metal sheets 10 and 14.

The wide range of applicability and advantage of pre-chilling the site where a weld nugget is to be formed is demonstrated by the following examples.

### EXAMPLE 1

In a first example, the metal sheets 10 and 14 can be of relatively thin gauge, hot-dip galvanized (HDG) low carbon steel, i.e., <0.7-mm thick. Ordinarily the making of a resistance spot weld between two relatively thin sheets of Zn-coated low carbon steel can be problematic because the weld is susceptible to excessive nugget penetration into both of the thin sheets. We have found that chilling and reducing the temperature of one or both of the thin sheets reduces the interface temperature between the two sheets and thereby increases the interface resistance at the faying interface where the nugget is to be formed. By reducing the temperature at the faying interface, the heating, weld initiation and nugget growth at the faying interface are promoted and the tendency toward excessive nugget penetration is controlled. The higher resistance at the faying interface is accomplished by pre-chilling of the metal sheets and establishes a larger temperature gradient from the faying interface to the point of contact of the electrode with the metal sheets, thereby allowing the electrodes to run cooler and last longer.

Although it is preferable to chill both the sheets as shown in FIG. 5, it is also possible to chill only one sheet as shown in FIG. 3, and the second sheet 14 will act as a heat sink to draw heat away from the first sheet 10 and thereby accomplish a pre-chilling of both metal sheets 10 and 14, even though the chilled air is being flowed onto only one of the sheets.

### EXAMPLE 2

In example 2, the metal sheets 10 and 14 are both HDG low carbon steel but of different thickness. For example, first sheet 10 can be 1.5 mm in thickness and second sheet 14 can be of only 0.5 mm thickness. In conventional welding, the proper formation of the weld nugget 22 can be difficult, and, in particular, is susceptible to having insufficient penetration of the nugget 22 into the thinner of the metal sheets. We have found that chilling and reducing the temperature at the faying interface increases the interface resistance between the two sheets at the interface where the nugget is to be formed. By reducing the interface temperature, the heating, weld initiation and nugget growth at the faying interface are promoted and the tendency toward insufficient growth and penetration of the weld 22 into the thinner sheet of metal is advantageously controlled and minimized. Although it is preferable to chill both sheets, if only one sheet is to be chilled, it is preferable to chill the thinner sheet to more rapidly cool the interface between the thicker and thinner sheets.

### EXAMPLE 3

In example 3, the sheets 10 and 14 are of equal thickness but of different material. For example the lower sheet 2 can be in a Zn-coated AHSS alloy such as TRIP steel and the upper sheet 14 can be a HDG sheet of low carbon steel. It is characteristic that the AHSS alloy has higher resistance and the low carbon steel has relatively lower resistance. In conventional welding there is a tendency to insufficient penetration into the low resistance sheet and excessive penetration into the high resistance sheet. We have found that chilling and reducing the temperature of one or both of the sheets reduces the interface temperature and increases the interface resistance thereby promoting heating, weld initiation and nugget growth at the faying interface. The result is improved penetration into the low resistance sheet, in this case the low carbon steel and reduced penetration into the AHSS. Although it is preferable to chill both sheets using the apparatus of FIG. 3, alternatively, the chilling of the higher resistance AHSS alloy sheet will create a thermal sink that helps prevent an overheating of that material. The higher resistance created at the faying interface establishes a larger temperature gradient from the faying interface to the interface of the electrode with the metal sheet thus allowing the electrodes to run cooler and last longer especially on the AHSS alloy sheet. By avoiding the overheating of the AHSS alloy sheet we also reduce the size of the heat affected zone and reduce the tendency toward cracks in the weld surface.

### EXAMPLE 4

The invention is also useful when the metal sheets differ in both thickness and material. For example the first sheet 10 can be a relatively thicker sheet of a Zn-coated AHSS alloy steel. The second sheet 14 can be a relatively thinner sheet of HDG low carbon steel. In conventional welding of a thin low resistance steel to a high resistance steel there is a tendency toward no penetration of the weld nugget into the thinner sheet and excessive heating and nugget penetration into the thicker sheet. By chilling and reducing the temperature at the faying interface and increasing the interface resistance, we are able to promote heating, weld initiation, and nugget growth at the faying interface and thereby improve the penetration of the weld nugget 22 into the thinner sheet of low resistance steel. It is preferable to chill both sheets as in FIG. 3 above. Alternatively however, the cooling of the thinner sheet will rapidly transfer heat away and cool the interface where the nugget is to be formed. In addition, by reducing the overheating of the thicker AHSS alloy sheet we are able to extend the electrode life and reduce deleterious effects of overheating such as the formation of weld surface cracks.

### EXAMPLE 5

Pre-chilling of the weld site is also advantageous in welding together an aluminum sheet and a steel sheet. In conventional resistance spot welding, the nugget 22 will have excessive penetration into the aluminum sheet since it has a melting temperature far below that of the steel sheet. By pre-chilling and reducing the temperature of the aluminum sheet a thermal sink is created that helps prevent excessive penetration into the aluminum sheet caused by heat flowing from the higher resistance steel sheet. It is preferable to chill only the aluminum sheet to best accomplish reduced penetration of the weld nugget into the aluminum sheet and thereby reduce the occurrence of weld expulsion and electrode wear.

### EXAMPLE 6

The invention is also useful in a welding together first and second aluminum sheets of different alloy material. For example, first sheet 10 can be an alloy of precipitation hardened aluminum 6XXX or 7XXX such as 6111-T4, 6022-T4, or 7055-T6 and the second sheet 14 can be an alloy of solid solution strengthened aluminum 5XXX such as 5754-O or 5182-O. In conventional welding, precipitation hardened alloys can result in a large softened heat affected zone (HAZ). Chilling and reducing the temperature of these precipitation hardened materials creates a thermal sink that reduces the extent and severity of the heat affected zone thereby limiting material softening around the formation of the nugget 22. Pre-chilling of both sheets or pre-chilling of one of the sheets will be beneficial to reducing the heat affected zone and reducing the occurrence of softening of the alloy material.

### EXAMPLE 7

The invention is also useful in instances where the metal stack includes three metal sheets. For example, two of the sheets can be HDG low carbon steel of 1.5 mm in thickness, while a third sheet of 0.5 mm thickness HDG low carbon steel is positioned atop the two thicker sheets. Thus, the three-piece metal stack includes the thinner sheet as an outermost sheet in the stack. During the welding, a weld nugget is formed between the two thicker sheets and a weld nugget is formed between the thinner outer sheet and the adjacent thicker sheet. In conventional welding, the proper formation of the weld nuggets is difficult, and, in particular, is susceptible to having insufficient penetration of the nugget into the thinner of the metal sheets. We have found that chilling and reducing the temperature at the faying interfaces increases the interface resistance between the three sheets at the interface where the nuggets are to be formed. By reducing the interface temperature, the heating, weld initiation and nugget growth at the faying interface are promoted and the tendency toward insufficient growth and penetration of the weld into the thinner sheet of metal is advantageously controlled and minimized. All three sheets can be chilled, or if only one sheet is to be chilled, chilling of the thinner sheet will more rapidly cool the interface between the thicker and thinner sheets.

It will be understood that each of the afore described examples 1 through 6 can be practiced with tools shown in either FIG. 1, 3 or 5. In general, the metal sheets will enter the welding process with the sheets at ambient temperature of the manufacturing plant. Then, the foregoing method and tools are utilized to chill the weld site by at least 5 degrees Celsius to obtain improved welding together of difficult to weld materials as described herein.

The apparatus shown in FIGS. 1, 3, 4, and 5 can be operated to obtain a wide range of operating conditions as needed to optimize the pre-chilling of the weld region of the metal sheets. For example, the apparatus of FIG. 1 can be employed to achieve the pre-chilling with only the use of chilled fluid, preferably water. After first contacting the metal sheets with the electrodes, chilled coolant circulates within the electrode to draw heat away from the metal sheets. After the desired chilling is obtained, the application of weld current is initiated between the electrodes. The cooling fluid preferably continues to circulate during the application of weld current to continue to carry heat away from the weld site.

The apparatus of FIG. 5 can be operated to achieve cooling of one or both of the metal sheets 10 and 14 by operating the valves 60 and 62 selectively to either turn off, turn on, or modulate the flow of chilling gas. In addition, the valves 60 and 62 can be operated to flow the chilling gas onto the metal sheets while one or both of the electrodes is being advanced toward contact with metal sheets. Or the valves can be operated to flow the chilling gas onto the metal sheets only after contact of the electrodes with the metal sheets has been achieved. In addition, the valves 60 and 62 can be selectively operated to continue to flow the chilled gas onto either one or both of the metal sheets during the application of weld current to the electrodes and/or for an additional selected period of time after the weld current has terminated.

Thus, the weld apparatus disclosed herein is selectively controlled to determine the relative degree of pre-chilling of two metal sheets as may be needed to optimize the welding process over a wide range of variables including differing thicknesses of the metal sheet, differing materials of the metal sheets, and other differences in the two metal sheets being welded together.

What is claimed is:

1. A method for improving the resistance spot welding of two or more stacked metal sheets, comprising:
providing at least a first metal sheet;
providing at least a second metal sheet;
stacking the metal sheets to make a metal stack;
positioning first and second opposed electrodes on opposite sides of the metal stack;
chilling at least one of the metal sheets in a region where a weld is to be made;
and applying weld current to the first and second electrodes and through the metal stack to create an electric resistance spot weld between the metal sheets only after the chilling of the region of the at least one metal sheet in the region where the weld is to be made.

2. The method of claim 1 further comprising cooling the region of the at least one metal sheet by at least 5° Celsius.

3. The method of claim 1 further comprising chilling the region of the at least one metal sheet by contacting an electrode with at least one of the metal sheets and circulating chilling water through the interior of the electrode for a period of time sufficient to cool the region prior to applying weld current to the electrodes.

4. The method of claim 1 further comprising chilling the region of the at least one metal sheet by flowing a chilled gas onto the at least one metal sheet prior to applying weld current to the electrodes.

5. The method of claim 4 further comprising flowing the chilled gas onto the at least one metal sheet prior to contacting the electrode with the at least one metal sheet.

6. The method of claim 4 further comprising flowing the chilled gas onto the at least one metal sheet both prior to contacting the electrode with the at least one metal sheet and while the electrode is contacting the at least one metal sheet.

7. The method of claim 4 further comprising continuing to flow the chilled gas onto the at least one metal sheet while the weld current is being conducted through the electrode and through the metal stack.

8. The method of claim 4 further comprising flowing chilled gas onto the at least one metal sheet during at least two time periods chosen among:
prior to contacting electrode with the at least one metal sheet;
during contact of the electrode with the metal sheet but prior to flowing weld current through the metal stack;
during the flow of electric current; and
after the flow of electric current.

9. The method of claim 1 further comprising the chilling all sheets of the metal stack prior to applying weld current to the electrode and the metal sheets.

10. The method of claim 1 further comprising the chilled gas being flowed onto the at least one metal sheet by gas flow nozzles carried on the electrode for movement toward and away from the at least one metal sheet in conjunction with movement of the at least one electrode.

11. A method for improving the resistance spot welding of two or more stacked metal sheets, comprising:
providing the metal stack;
positioning first and second opposed electrodes on opposite sides of the metal stack;
flowing chilled gas onto the outer surface of the metal stack to cool a region where a weld is to be made;
and applying weld current to the first and second electrodes and through the metal stack to create an electric resistance spot weld between the stacked metal sheets after chilling of the outer surface has lowered the temperature at a faying interface between the stacked metal sheets.

12. The method of claim 11 further comprising applying weld current to the first and second electrodes after the temperature at a faying interface between the metal sheets has been lowered in the range between 15 degrees Celsius and 35 degrees Celsius.

13. The method of claim 11 further comprising metal stack including metal sheets having different characteristics including at least one of different thicknesses, different metal alloys, and different surface coatings.

14. The method of claim 11 further comprising the chilled gas being flowed onto the surface of the metal stack by first and second gas flow nozzles carried respectively by the first and second electrodes for movement toward and away from the metal stack.

15. The method of claim 14 further comprising providing first and second operating valves supplying chilled gas respectively to the first and second gas flow nozzles of the first and second electrodes and operating the first and second valves to selectively control the flow and flow rate of the chilled gas to enable variable chilling of outer surfaces of the metal stack.

16. The method of claim 15 further comprising selectively operating the operating valves to flow chilled gas onto surfaces of the metal stack during at least two time periods chosen among:
prior to electrode contact with the metal stack;
during contact of the electrode with the metal stack but prior to flowing weld current through the metal stack;
during the flow of electric current; and
after the flow of electric current.

17. The method of claim 16 further comprising applying weld current to the first and second electrodes only after the temperature at a faying interface between the metal sheets has been lowered by at least 5° Celsius.

18. A method for improving the resistance spot welding of two or more stacked metal sheets, comprising:
providing the metal stack, at least one of the metal sheets of the metal stack having different thickness or material from another of the metal sheets;
positioning first and second opposed electrodes on opposite sides of the metal stack;
operating one or more valves to flow chilled gas onto a surface of the metal stack to cool a region where a weld is to be made and obtain a lowering of the temperature at the faying interface between the metal sheets of at least 5 degrees Celsius;
and applying weld current to the first and second electrodes and through the metal stack to create an electric resistance spot weld between the metal sheets only after the lowering of the temperature at the faying interface between the first and second metal sheets by at least 5 degrees Celsius.

19. The method of claim 18 further comprising selectively operating the operating one or more valves to flow chilled gas onto the surface of the metal stack during at least two time periods chosen among:
a period prior to contacting an electrode with the metal stack;
a period during contact of an electrode with the metal sheet but prior to flowing weld current through the metal stack;
a period during the flow of electric current; and
a period after the flow of electric current.

20. The method of claim 19 further comprising the chilled gas being flowed onto the outermost surfaces of the metal stack by first and second gas flow nozzles carried respectively by the first and second electrodes for movement toward and away from the outermost surfaces of the metal stack and the flow of chilled gas being controlled by operating valves selectively operable to control the flow and flow rate of the chilled gas to enable variable chilling of the first and second metal sheets as needed to obtain a temperature reduction of between 5 degrees Celsius and 35 degrees Celsius at the faying interface of the metal sheets.
